(19) United States
(12) Patent Application Publication
(10) Pub. No.: US 2002/0044450 A1
(43) Pub. Date: Apr. 18, 2002

(54) Fog lamp mounting structure of an automobile

(76) Inventor: Se Wook Oh, Koonpo-shi (KR)

Correspondence Address: CHRISTIE, PARKER & HALE, LLP, P. O. Box 7068, Pasadena, CA, 91109-7068, US

(21) Appl. No.: 09/752,255

(22) Filed: Dec. 29, 2000

(30) Foreign Application Priority Data
Aug. 24, 2000 (KR) 2000-49254

(51) Int. Cl. B60Q 1/00

(52) U.S. Cl. 362/505; 362/546

(57) ABSTRACT

The present invention relates to a fog lamp mounting structure of an automobile wherein said fog lamp mounting structure comprises a reflector 14 which reflects the lights of a light bulb 20 in the lamp, a folder 12 which holds the body frame of a vehicle, and a dust cover 16 which is mounted on the rear end and prevents the entrance of impurities inside the fog lamp 10, are manufactured as an integrated body by means of injection molding and mounted subsequently, thus enabling the improvement in workability as well as cost reduction.

### BACKGROUND OF THE INVENTION

1. Field of the Invention

The present invention relates to a fog lamp mounting structure of an automobile wherein members of said fog lamp are manufactured as an integrated body by means of injection molding thus reducing production cost as well as improving workability.

2. Description of the Prior Art

Fog lamps have been introduced to automotive vehicles as a safety measure to improve the visibility under foggy conditions. Typically, the fog lamps are mounted on both sides of a front bumper of a vehicle so that they can improve the poor visibility in the front of a vehicle and also enable to warn other vehicles coming nearby via the light emitted from said fog lamp.

The conventional type of fog lamp mounting structure is shown in FIG. 2. This figure shows that lens is joined on the front of a folder 12, a light bulb is connected to a reflector 14 by a screw, and the rear part of said reflector 14 is covered with a dust cover fixed on a fog lamp mounting bracket in order to prevent the penetration of impurities into the fog lamp. However, the conventional fog lamp mounting structure is not advantageous in that it is formed by assembling its members comprising a folder, a reflector, a dust cover, which are formed independently by injection molding, thus incurring higher production cost as well as inefficient workability due to requirement of more parts and time for joining each member.

### SUMMARY OF THE INVENTION

Therefore, the object of the present invention is to provide a fog lamp mounting structure of an automobile which can remedy the above-mentioned drawbacks of the conventional fog lamp mounting structure, the members of which are formed integrally by injection molding thus enabling to improve workability in mounting said fog lamp as well as to reduce production cost.

### BRIEF DESCRIPTION OF THE DRAWINGS

FIG. 1 shows a cross-sectional view of a fog lamp mounting structure of an automobile according to the present invention.

FIG. 2 shows a cross-sectional view of conventional fog lamp mounting structure of an automobile.

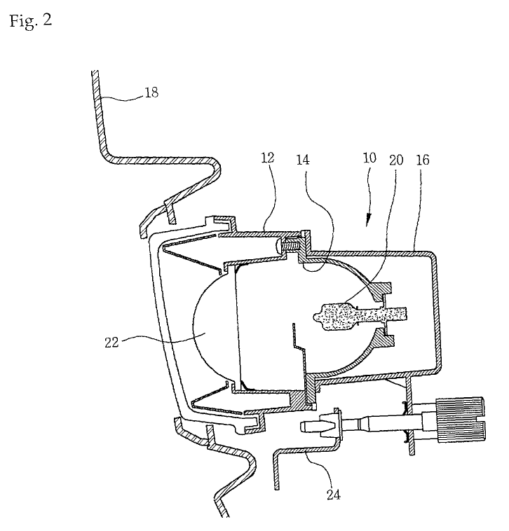

[Code Explanation of the major parts]

| | |
|---|---|
| 10: fog lamp | 12: folder |
| 14: reflector | 16: dust cover |
| 18: front bumper | 20: light bulb |
| 22: lens | 24: bracket |
| 100: an integrally formed body | |

### DESCRIPTION OF THE PRESENT INVENTION

The present invention relates to a fog lamp mounting structure of an automobile, wherein members of said fog lamp mounting structure comprises a reflector 14 which reflects the lights of a light bulb 20 in said lamp, a folder 12 which holds the body frame of a vehicle, and a dust cover which is mounted in the rear end of said reflector 14 and prevents the entrance of impurities inside the fog lamp 10 manufactured as an integrated body by means of injection molding and mounted subsequently, thus enabling the improvement in workability as well as reduction in production cost.

The features and advantages of the present invention will be described more clearly with reference to the accompanying drawings as set forth hereunder.

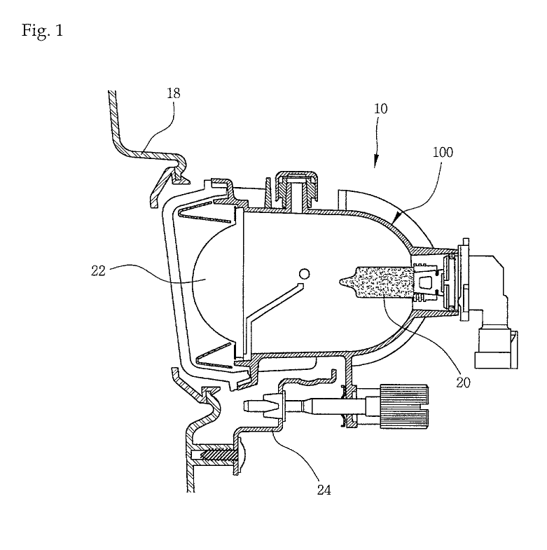

FIG. 1 shows a cross-sectional view of a fog lamp mounting structure of an automobile according to the present invention wherein code number 100 represents an integrally formed part comprising a folder 12, a reflector 14 and a dust cover 16. The front end and the rear end of said integrally formed part 100 are molded so that a lens 22 and a light bulb 20 can be appropriately mounted, respectively and reflector surface is formed in the internal surface. A lens 22 and a light bulb 20 are accordingly assembled into the front end and the rear end of said integrally formed part 100, respectively, as an integral body and then the resulting whole body is mounted directly onto a fog lamp mounting bracket 24 or a bumper by means of a screw or the like. Further, since the fog lamp mounting structure of the present invention comprising a folder 12, a reflector 14 and a dust cover 16 is formed as an integral part, the compatibility of said fog lamp mounting structure of the present invention with any automotive vehicles can be easily checked out.

Consequently, unlike conventional fog lamp mounting structures wherein each member is separately formed and then joined together as a whole, the present invention provides a novel fog lamp mounting structure comprising a folder, a reflector and a dust cover formed as an integrated part and it thus can improve the workability in mounting said fog lamp and reduce the manufacturing cost.

What is claimed is:

1. A fog lamp mounting structure of an automobile comprising a folder wherein a lens is assembled into its front, a reflector wherein a light bulb is plugged into its center, and a dust cover which is mounted on the rear end of said reflector, wherein said folder, said reflector and said dust cover are formed as an integrated body by means of injection molding and mounted instantly thereof.

2. The fog lamp mounting structure of an automobile according to claim 1, wherein a lens and a light bulb are assembled into said integrally formed body and then the resulting body is mounted further as a whole.

3. The fog lamp mounting structure of an automobile according to claims 1 and 2, wherein said integrally formed body comprising said folder, said reflector and said dust cover are directly mounted onto a fog lamp mounting bracket or a bumper.
